(19) United States
(12) Patent Application Publication
(10) Pub. No.: US 2005/0278216 A1
(43) Pub. Date: Dec. 15, 2005

(54) System and method for distributing an identifier redeemable for a plurality of products

(75) Inventor: Phillip Craig Graves, Atlanta, GA (US)

Correspondence Address: HUNTON & WILLIAMS LLP;INTELLECTUAL PROPERTY DEPARTMENT, RIVERFRONT PLAZA, EAST TOWER, 951 EAST BYRD ST., RICHMOND, VA, 23219-4074, US

(73) Assignee: e2interactive, Inc. d/b/a e2Interactive, Inc., Atlanta, GA (US)

(21) Appl. No.: 10/864,809

(22) Filed: Jun. 10, 2004

(51) Int. Cl. G06F 17/60

(52) U.S. Cl. 705/14; 705/1

(57) ABSTRACT

In one exemplary embodiment, a system and method for distributing an identifier is provided. A database comprising a plurality of unique identifiers is established, wherein each identifier is associated with a set of products and is redeemable for a plurality of the set of products. Indicia of a selected one of said plurality of unique identifiers is distributed to a customer. A first request to redeem the selected identifier for a first product is received from the customer. It is determined whether to authorize redemption of the selected identifier for the first product. An authorization result message is issued to the customer.

### FIELD OF THE INVENTION

This invention relates to distributing identifiers usable to access value. More particularly, the invention relates to distributing a single identifier that can be used to redeem a plurality of different product through a plurality of different distribution channels.

### BACKGROUND OF THE INVENTION

Identifiers such as personal identification numbers (PINs) can be used to access value and sensitive information stored in accounts associated with the specific PINs. Because a PIN is typically unique and known only to the individual accountholder, PINs can verify an accountholder's identity and thereby authorize accountholder access to account value. Typically PINs are long enough that it would be difficult or impractical for someone to guess them randomly. Provided the PIN is kept secret, a PIN owner may access account value and/or confidential information with little fear of theft. Additionally, a PIN can be memorized or carried with a PIN owner. Thus, a PIN owner may access the value from anywhere. Because PINs are usually associated with an automated redemption system, the PIN value or information can typically be accessed at any time.

Because PINs can be provided at any account access point, such as a computer terminal, PINs dramatically increase the times and places that an accountholder can access the account. For instance, bank accountholders can provide their PIN and thereby access account information or pay bills via ATM machines and personal computers instead of physically going to a physical bank building during regular business hours.

Thus, PINs are an ideal way to enable customers to access or redeem value in an account. Stated another way, PINs are an efficient means for merchants to distribute value to customers. I.e., merchants may distribute PINs to customers rather than distribute products, and customers can later use the PIN to redeem the value or good. Thus, PINs can effectively be used to shift the time of distribution to a later time at the convenience of the customer. For instance, a telecommunications service provider may distribute telecommunication service value by distributing a PIN associated with an amount of telecommunication value. For instance, a telecommunications card (phone card) and an associated PIN may be distributed to a customer at a point of sale. The card and PIN may be associated with a stored value account at a central processor, such as an account storing telecommunications service value stored by a telecommunications service provider. At a time and place of the customer's choosing, the customer may access the telecommunications provider's system and then provide the PIN to access the stored account value, such as minutes of telecommunications service. Upon verification of the PIN, the telecommunications provider may then provide telecommunications service to the customer.

Typically a PIN is associated with a single account and a single value. For instance, a PIN may be used to access information for a specific account or to access value for a single account. Typically the value is of a specific single type, such as telecommunication minutes, dollars, or points. Thus, merchants typically distribute PINs to customers who then redeem the PIN for a single product or product type. For instance, a phone card PIN is typically redeemed only for a phone minutes, and a bank PIN can only redeem money from the account.

### SUMMARY OF THE INVENTION

In one exemplary embodiment, a system and method for distributing an identifier is provided. A database comprising a plurality of unique identifiers is established, wherein each identifier is associated with a set of products. Indicia of a selected one of said plurality of unique identifiers is distributed to a customer. A first request to redeem the selected identifier for a first product is received from the customer. It is determined whether to authorize redemption of the selected identifier for the first product. An authorization result message is issued to the customer.

In another exemplary embodiment, a method of distributing an identifier is provided. A request for a product based on a unique identifier is received. The product is one of a set of products associated with the identifier in a database, and the identifier is usable to redeem each of the set of products. The product is distributed to a customer.

In another exemplary embodiment, a system for distributing an identifier is provided. A database is configured to store a plurality of unique identifiers, wherein each identifier is associated in the database with a set of products and is redeemable for a plurality of the set of products. An output device is configured to pass indicia of a selected one of said plurality of unique identifiers for distribution to a customer. An input device is configured to receive a first request from the customer to redeem the selected identifier for a first product. A processor is configured to determine whether to authorize redemption of the selected identifier for the first product. An output device is configured to issue a first authorization result message to the customer.

In yet another exemplary embodiment, a method of providing a PIN is provided. A PIN is provided with a product, wherein the PIN is associated with a plurality of products, each product is separately redeemable, and each product is redeemable through a separate distribution channel. A first request to redeem a first product is received, wherein the first request comprises the PIN. It is determined whether the PIN is associated with the first product. The first product is redeemed through a first distribution channel. A second request to redeem a second product is received, wherein the second request comprises the PIN. It is determined whether the PIN is associated with the second product. The second product is redeemed through a second distribution channel.

Other embodiments could be considered.

### BRIEF DESCRIPTION OF THE DRAWINGS

FIG. 1 illustrates a system for distributing a product according to an embodiment of the invention.

FIG. 2 shows a system for distributing and activating an identifier according to an embodiment of the invention.

FIG. 3 shows an exemplary product comprising an identifier according to an embodiment of the invention.

FIG. 4 shows an exemplary card product comprising an identifier according to an embodiment of the invention.

FIG. 5 shows a method of distributing an identifier to a customer according to an embodiment of the invention.

### DETAILED DESCRIPTION OF THE EMBODIMENTS

The invention provides systems and methods that enable customers to purchase one or more of a set of products through the use of a single identifier such as a PIN. As discussed in more detail below, these methods may include providing an identifier such as a PIN to a customer in any of various ways. The identifier may be operative to redeem one or more of a set of products that have been associated with the identifier in a database maintained by a central processor. The customer may access the central processor or a particular product provider and request that the identifier be redeemed for one of the set of products. A redemption request may be forwarded to the central processor or provider either by the customer himself or by a retailer or other intermediary. If approved by the central processor, a redemption authorization is provided and the product may be provided to the customer. In some embodiments, the customer may use the same PIN more than once to obtain additional products. The redemption request may be communicated over the same or different communication channels for each product redemption. A plurality of different providers may provide the products through a plurality of different distribution channels.

The identifier may be associated (e.g., in the database) with one or more predetermined goods or services (collectively, “products”), one or more good or service providers (collectively, “product providers”), one or more communication networks, one or more redemption channels, one or more accounts, and one or more points of redemption.

Identifiers may be distributed in a variety of ways. For instance, identifiers such as PINs may be printed on cards that may be sold or otherwise distributed to customers at merchant stores. An identifier may be printed on a receipt provided to a customer, e.g., upon purchase of a particular product. An identifier may be packaged with a product; for instance, a customer may select or purchase one product, and the identifier may attached to the product, enclosed with the product or its packaging, printed on the product itself, or otherwise coupled to the product or its packaging.

In a particular embodiment, an identifier may be distributed along with a separate product as extra incentive to purchase that product. For example, prepackaged merchandise purchased from a retailer may include indicia inside the sealed package that includes a unique identifier that may be redeemed for other products related (or unrelated) to the purchased merchandise.

By way of example, a customer or other end-user (“customer”) may receive a product that contains an identifier such as a PIN, wherein the identifier is pre-associated with a set of products for which it may be redeemed. The customer may then contact a central processor, either directly or with the assistance of an intermediary merchant, to request to redeem the identifier for a first product. Typically, the request will include the identifier and may also include an identification of the product desired. The central processor may then determine whether the redemption request is valid. For instance, the central processor may access a database of identifiers and verify that the identifier is valid and that the identifier has not yet been redeemed for the requested product. The central processor may pass a redemption authorization response to the redemption requester (i.e., the customer or an intermediary merchant) in the form of a confirmation that the first product will be redeemed. The central processor may then initiate a process to provide the first product to the customer. For instance, the central processor may request a first provider to provide the first product to the customer. Alternatively, if the request is made through a retailer, the authorization may instruct or authorize the retailer to provide the product to the customer. The central processor may then amend the database to reflect that the first product was redeemed for the identifier. Depending on the embodiment, the process may be repeated when the customer subsequently requests to redeem the identifier for a second product or for a second one of the first product.

It will be understood that the identifiers provided in the methods of the invention may be used to access any of a variety of products. Examples of products and services that may be accommodated, redeemed, or accessed by identifiers include: long distance telephone communication, wireless communication, paging and internet-enabled communication services (such as wireless web access), emergency road service, legal service, accounting service, tax service, property cleaning and/or maintenance service, clothe cleaning service, transportation service, call service (e.g., wake-up call service), travel service, delivery service, online (or off-line) dating service, electrical and/or gas service, water service, sewage service, internet access, and film processing (including digital film processing). Other examples of prepaid products and services that may be accessed by an identifier include: gift accounts, prepaid gas accounts, prepaid grocery accounts, prepaid entertainment accounts, prepaid movie accounts, downloadable ring tone accounts, downloadable game accounts, downloadable image accounts, downloadable video or movie accounts, downloadable music accounts (e.g., for music files that use MP3, MP4, WMV, WAV, or other formats), any other downloadable software account, customer rewards accounts, bridge and/or road toll accounts, and any other type of value that may be accessed via an identifier.

The products associated with an identifier may also include merchandise. For instance, the product may be a video game, a video game console, a transaction card (such as a credit card, debit card, or stored value card), an audio-visual product (such as a DVD, CD, downloadable music card), a concert ticket, or a gift certificate. Associated products may also include software or other downloadable content.

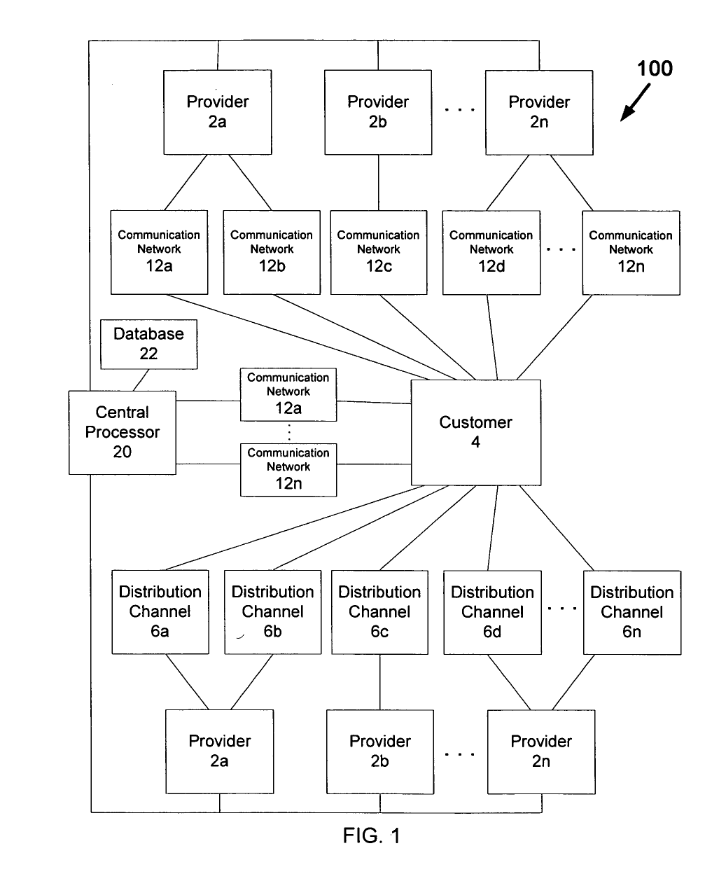

FIG. 1 illustrates a system 100 for distributing a product according to an embodiment of the invention. The system 100 comprises one or more providers 2a-2n, each of which may be selectively in communication with a customer 4 and/or a central processor 20 via one or more communication networks 12a-12n. The central processor 20 may be coupled to a database 22 that stores one or more identifiers (e.g., unique identifiers) as well as information associated with each identifier, such as information relating to products that may be redeemed by the identifier (or the redeemable products themselves, such as downloadable content). Each provider 2 may be configured to provide a product to the customer 4 via one or more distribution channels 6a-6n.

A customer 4 may pass a request for one or more products to a central processor 20 either directly or through an intermediary. Communications (e.g., requests and responses) may be passed between and among the different entities via one or more communication networks 12a-12n. The communication networks 12a-12n may comprise any communication device or network for communicating between one party (e.g., a customer) and another (e.g., a merchant, provider, or central processor). Technologies used to provide such communication might include a network (such as a telephone or computer network), a dedicated circuit, an IP based connection, the Internet, Intranet, Extranet, LAN, WAN, VPN, an Ethernet, or any client server system that provides communication, for example. Such communications technologies may use any suitable protocol such as TCP/IP, UDP, OSI, SNA, X.25, ISO 85/83, XML or SOAP, for example. The communication network may pass data between and among one or more merchant terminals 10a-10n and a central processor 20.

Alternately, the customer may pass the request for one or more products directly to one or more providers 2a-2n via one or more communications networks 12a-12n.

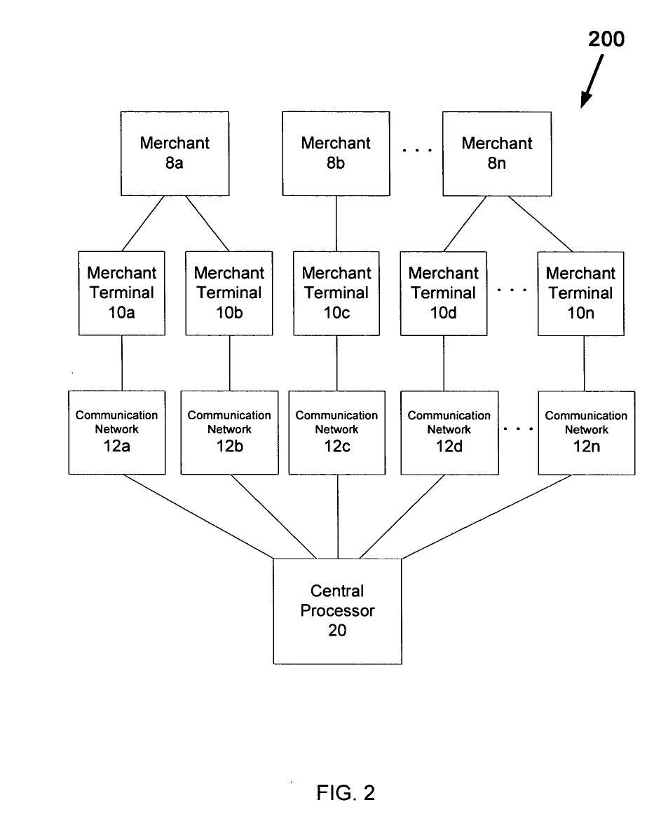

FIG. 2 shows a system 200 for distributing and activating an identifier according to an embodiment of the invention. A merchant 8a-8n may distribute an identifier and/or an associated product to a customer, e.g., in a merchant store. For instance, a customer may purchase the product and/or identifier at a merchant terminal 10a-10n. The identifier may then be used to redeem one or more of a set of predetermined products, which may be associated with the product purchased at the merchant terminal 10. For instance, the customer may purchase a concert ticket for a famous musician, and an identifier such as a PIN may be printed on a receipt or on the ticket itself. After the concert, the PIN may be used to obtain a poster of the musician and to download songs performed by the musician at the concert. In another example, the customer may purchase a CD featuring the same musician, and a card with an identifier printed on it is disposed within the CD package. The identifier may then be redeemed, for example, for additional songs downloaded from the Internet.

In some instances, an identifier may require activation before it may be redeemed or used by a customer. For example, a customer may receive a PIN that is redeemable for one of a set of prepaid services. The PIN may be activated at the time it is received by the customer. For instance, when the PIN is received with an associated product purchased at a merchant terminal 10, the merchant terminal 10 may pass an activation message to a central processor 20 via a communication network 12. The central processor 20 may activate the identifier by amending a database 20 storing identifier information, such as activation information and information about the set of products associated with the identifier (e.g., redemption information). The central processor 20 may then pass an activation confirmation message back to the merchant terminal 10. The merchant terminal 10 may then pass an activation confirmation to the customer 4.

The central processor 20 may be any server, computer, computer system, hub, database, data processor, credit network, or other computer system, or any other processor. The central processor 20 may be configured to process data received from merchants 8 and merchant terminals 10. The central processor may also be adapted for direct communication with a customer over a telephone network or via a data processing network such as the Internet.

A merchant terminal 10 may comprise any terminal at a merchant 8 used to process customer transactions. A merchant terminal 10 may comprise a cash register, magnetic stripe reader, credit card terminals, or an ATM. A merchant terminal 10 may be inside a merchant 8 store. For instance, a customer may purchase a product, and the purchase transaction may be processed at a merchant terminal 10.

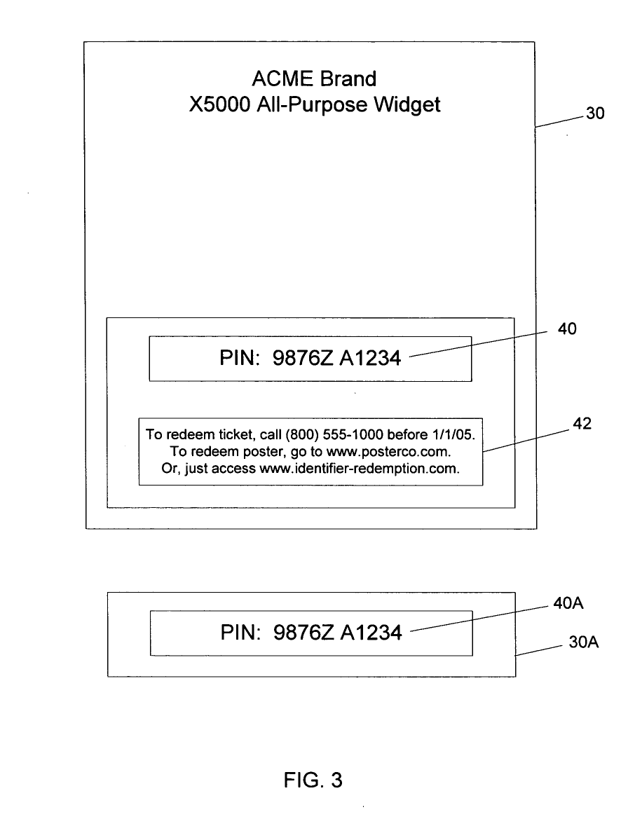

FIG. 3 shows an exemplary product comprising an identifier according to an embodiment of the invention. As shown in FIG. 3, a product 30 may comprise an indicia 40. Here, the product is an “ACME Brand X5000 All-Purpose Widget,” although it will be appreciated that the product may be any type of product.

The product 30 may be any other good or service that may be associated with an indicia 40 of an identifier, such as a CD, DVD, ticket, phone card, other stored value card, other financial product, or other good or service. In some embodiments, there may be no product; rather, the indicia 40 may be provided to a customer separately from any product. In some embodiments, the “product” 30 may be an indicia of service. For instance, the indicia may comprise a receipt, such as a receipt for providing a product or service, or the indicia may comprise another communication related to a product or service. The product may also be an electronic product, such as a file download (e.g., music file download or video game), web page access, email, or other electronic file or program.

The indicia 40 may be any writing, printing, or other audio-visual means of communicating an identifier, or it may comprise information not disclosed visibly. For instance, the indicia may comprise an RFID device capable of communicating the identifier to an authorized receiver device. The identifier may be any number or code, such as “9876Z A1234,” as shown in FIG. 3. The indicia 40 may be included with (or on) the product 30, or it may be provided separately. FIG. 3 shows an indicia 40 printed on the product and another indicia 40A provided on a receipt or other communication 30A separate from the product 30. Thus, the identifier may be provided on more than one indicia 30. However, in some embodiments the identifier may be provided only once. For instance, the identifier may be provided as shown in item 40 or as shown in item 40A, but not both.

The indicia 40 may have a physical embodiment, such as a sticker on a label of a product or a product container, or a printout on a receipt 30A. The indicia 40 may also be electronic. For instance, the indicia 40 may be an email, text message, voicemail message, or other communication that indicates the identifier. In some embodiments, the indicia may be sent electronically to the purchaser of the product (or to a recipient designated by the purchaser, or to another person). For instance, the email may be an indicia that lists the identifier in the text of the email. The indicia 40 may also be any other means of communicating the identifier to an end user.

The product 30 and/or indicia 40 may comprise identifier redemption instructions 42. The instructions 42 may indicate how an identifier may be redeemed for one or more associated products. For instance, the instructions 42 may provide provider information, redemption expiration dates, and any other data associated with the product 30, identifier, and/or other product redemption information. The instructions 42 may be provided with the identifier indicia 40 or another indicia. For security purposes, the instructions 42 may be provided to the user separately from the indicia 40. For instance, the indicia 40 may be provided with the product, while instructions 42 may be provided via mail (or email) after registering the product.

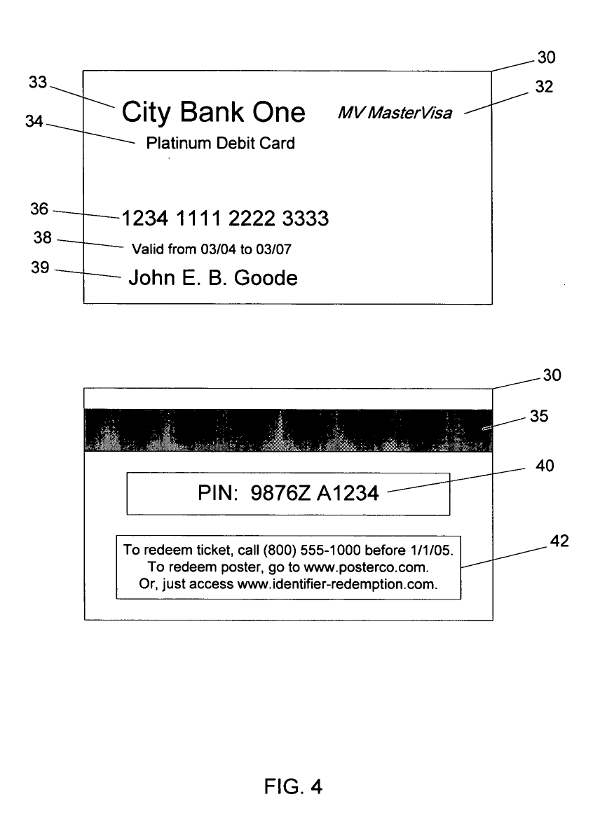

FIG. 4 shows an exemplary card product 30 and an indicia 40 of an identifier according to an embodiment of the invention. FIG. 4 shows the front view and rear view of the product 30. Here, the product is a transaction card 30, such as a credit card, debit card, phone card, or other stored value card. The card 30 may comprise an issuer indicia 33, a credit network indicia 32, a card title 34, an account number or card number 36, validity dates and/or expiration data 38, a cardholder name 40, a magnetic stripe 35, redemption instructions 42, and any other indicia of information associated with the account.

In the embodiment shown in FIG. 4, the indicia 40 is a number printed on a sticker (or other adhesive) attached to the back of the card. The identifier may or may not be coupled to a product (e.g., via an adhesive). In another embodiment, there may be no sticker indicia 40, and the card number 36 may instead be the indicia of the identifier.

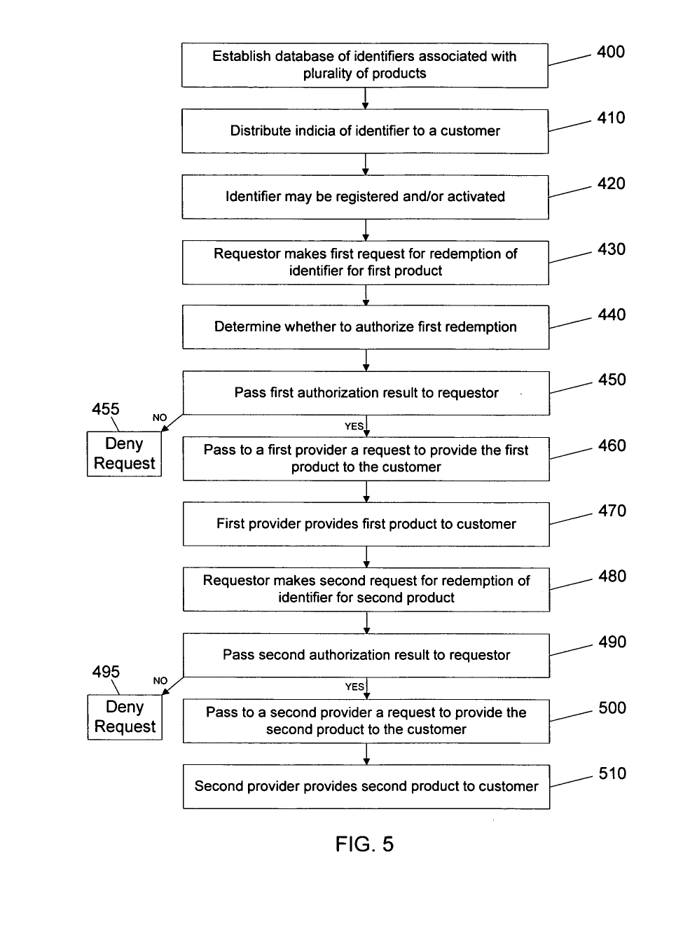

FIG. 5 shows a method of distributing an identifier to a customer according to an embodiment of the invention.

In step 400, a database of identifiers may be established, wherein identifiers are associated with a plurality of products. Each identifier may be associated (e.g., in the database) with a specific set of products, such as products that may be redeemed by providing the identifier. The database may store any information related to the identifiers or associated products, such as redemption or product distribution information. This information may be stored for each identifier in a separate database entry. For instance, each identifier may be associated with a product that is distributed with (e.g., attached to) an indicia of the identifier. Each identifier may also be associated with one or more providers, such as the providers who may provide the products associated with the identifier. Each identifier and/or each product associated with the identifier may also be associated with validity data, such as dates of validity (e.g., expiration dates). Each identifier and/or product associated therewith may be associated with a distribution channel for distributing the product to a customer and/or a communication network for passing information between a customer and a central processor (or provider) related to the product or identifier, such as a request for redemption of the product.

The database may also store redemption data for each product associated with a specific identifier. The database may be amended to indicate that a specific identifier has (or has not) been used to redeem a particular product.

For instance, a plurality of identifiers may be stored in a database. Each identifier may be associated with a concert ticket, a poster, and various downloadable music files. Each of the concert ticket, poster, and music files (and the identifier) may be associated with one or more providers. The concert ticket may be associated with TicketCo; the poster may be associated with PosterCo and MemorabiliaCo, and the music files may be associated with iMusicCo. The downloadable music files may further be associated with a particular distribution channel, such as the Internet. The ticket may be associated with a communication network, such as a phone network (and/or a specific 800 number that can be used by a customer to redeem the identifier for a ticket).

In step 410, indicia of an identifier may be distributed to a customer. As previously discussed, the indicia may be distributed in a variety of ways. The indicia may be distributed on or with a product that may be purchased by a customer. For instance, the indicia may be provided inside or on a DVD. For instance, the identifier may be on a sticker attached to the back of the DVD. The identifier may also be provided on a receipt when a customer purchases a product.

The identifier may be distributed in an active state. That is, it may be distributed so that it is immediately usable by whoever obtains it, regardless of how it was obtained. Alternatively, the identifier may be provided in an inactive state, in which case it must be activated before it can be used.

In step 420, the identifier may be registered and/or activated. This step may occur when the customer receives the identifier. For instance, the customer may purchase or otherwise obtain a stored value card (or other transaction card) from a merchant. The stored value card account number may be the identifier (or the identifier may be otherwise coupled to or associated with the card). During the purchase transaction, card information may be input at a merchant terminal. For instance, a magnetic stripe of the card may be swiped. The identifier may be activated when the card is swiped at a merchant terminal. The activation of cards at merchant terminals is well known in the art. For instance, during this process, the merchant terminal may pass card information (e.g., the identifier) to a central processor coupled to the database, and the central processor may then amend the database to reflect that the identifier has been activated. Activation may be contingent upon confirmation signals between the merchant terminal and central processor. For example, the central processor may not activate the identifier until it verifies that the product (the transaction card) has been validly purchased (e.g., that the customer's purchase funds have cleared).

In some embodiments, the identifier is not activated at the time of purchase of an associated product, but is instead activated upon separate request or upon first use by the customer. This may be advantageous as a marketing tool because it may require a return visit by the customer to the outlet where the associated product was purchased. In such embodiments, activation may carried out in much the same manner as described above.

In step 430, a request to redeem the identifier for a first product is passed to a central processor. This request may be submitted by a customer directly or may be submitted through a merchant. The request may comprise the identifier. For instance, the requester (i.e., the customer or merchant) may access a central processor or provider, e.g., via phone or Internet. The requestor may follow instructions for redemption (if provided, e.g., on the indicia). For instance, the requestor may access a central processor's website or phone number according to the instructions. Alternatively, the customer may present the identifier to a merchant who forwards a redemption request to the central processor or provider. In a particular embodiment, the merchant may be a provider of the product for which the customer wishes to redeem the identifier.

The request may indicate a selection of a particular product. For instance, the identifier may be redeemable for a plurality of different products, and the customer may only wish to obtain one of the products in a single redemption request. Thus, the requester may select from among a plurality of products (or product types) for redemption. For example, if an identifier is redeemable for a concert ticket as well as a number of downloadable songs (e.g., four songs), the customer may choose to redeem only the concert ticket.

Similarly, a single product redemption type may require (or allow) customer choice. For example, if the customer chooses to redeem the identifier for three of the four downloadable songs, the customer may select three songs for download from among a plurality of songs. For some kinds of products it may be desirable to permit the customer to obtain more than one of a particular product as an alternative to obtaining the same number of different products.

It should be noted that while the customer may select a single product for redemption in this step, the customer may redeem any number of products simultaneously according to some embodiments.

The central processor may prompt the requestor for the identifier. For instance, the requestor may access a web page associated with the central processor, and an input field may request the identifier. The requestor may then type (or otherwise input) the identifier and submit the information to the central processor, e.g., by pressing “return.”

In some embodiments, the identifier indicia may be provided in the form of a separate card having a magnetic strip or other machine readable storage medium having the identifier stored therein. In these embodiments, the redemption request may involve reading the identifier using a scanner or magnetic strip reader. A request, including the machine-read identifier may then be transmitted to the central processor.

In step 440, the central processor (or product provider) may determine whether to authorize redemption of the first product. For instance, the central processor (or provider) may access the database to determine any of (i) whether the identifier is valid; (ii) whether the identifier is redeemable for (and/or associated with) the requested product; (iii) whether the redemption request is timely (e.g., whether the requested redemption has expired); and (iv) whether the identifier has already been redeemed for the requested product. Based on one or more of these determinations (or other determinations related to the identifier and/or product), the central processor may determine to authorize or not authorize redemption of the product. For instance, the central processor may decide to authorize the product if it determines that the identifier is valid and redeemable for the requested product, the request is timely, and/or the identifier has not yet been redeemed for the requested product.

It will be understood that a wide variety of criteria may be used to determine authorization of a redemption request. These may include, for example, limitations on the number of particular products that may be obtained using a particular identifier, the total number of uses of an identifier or a total value of products obtained using the identifier.

In some embodiments, the identifier itself can be used to redeem products directly. For instance, the identifier may be (among other things) a valid PIN that may be used to access telecommunications service from a provider. The PIN may be activated in step 420, or it may be pre-activated. To redeem the telecommunications service (or a portion thereof), the customer may simply access the telecommunications provider and use the telecommunications service. The use of PINs to access telecommunications service is well known in the art.

In step 450, the central processor (or provider) may pass an authorization result to the requestor. If the central processor determines that the request should be granted, then the authorization result may be positive, i.e., the result may indicate that the request is being processed or that the product will be delivered, or some other indication that the customer will (or should) receive the product.

If the central processor determines that the request should not be granted, then the authorization result may be negative. For instance, if there is any problem with the redemption request and/or the identifier or requested good, the authorization result may indicate that the request has been denied. For instance, the request may be denied if any of the following are determined in step 440: (i) the identifier is not valid; (ii) the identifier is valid but not redeemable for the requested product; (iii) the request is not timely (e.g., not during a proper time of redemption, or expired); or (iv) the identifier has already been redeemed for the requested product or product type. Other invalidity criteria can be considered.

Step 455. If the central processor (or provider) determines not to authorize redemption of the first product, then the process may stop in step 455.

Step 460. If the central processor determines to authorize redemption of the first product, then a request to provide the first product to the customer may be passed to the requestor and/or a first provider in step 460.

It should be noted that this step 460 may occur if a provider separate from the central processor is responsible for redemption of the first product. If the central processor can provide the product, then it is not necessary to pass a redemption request to a first provider. Rather, the central processor may simply redeem the first product directly. If the requester is also the provider of the product requested, steps 450 and 460 may be combined.

In step 470, a first provider (or central processor) may provide the first product to the customer. Any method of distributing a product is contemplated herein. For instance, there may be a plurality of different distribution channels. Downloadable content may be delivered electronically via email or download. A poster or other physical product may be mailed or otherwise physically delivered to the customer, e.g., to the customer's mailing address. A coupon, gift certificate, and ticket may be mailed, or they may be delivered electronically (and printed). Telecommunications service may be obtained by accessing a telecommunications provider. However, a PIN that may be used to access the telecommunications service may be provided in this step through other distribution means.

It should be noted that the first provider may provide the first product to the customer via the central processor. For instance, the central processor may pass a request for redemption to the first provider in step 460, and the first provider may provide the product to the central processor, which may then provide the product to the customer.

For instance, if the central processor approves a customer's request for downloadable content in step 440, then the central processor may obtain the requested content from the provider and then enable the customer to download it from the central processor's website. For some products, like PINs used to access telecommunications service, the central processor may obtain the PINs earlier in the process, such as at the time the database is established in step 400 (or sometime thereafter).

For some products, the central processor and/or provider may redeem the product when they provide the customer with adequate instructions for obtaining the product. For instance, a banana split dessert may be redeemed when a provider (or central processor) provides the customer with a code that can be used to obtain a banana split at a particular dessert merchant on a specific day.

In step 480, the customer may make a request for redemption of the identifier for a second product. This step is similar to step 430 for the first product.

In step 490, a central processor (or provider) may determine whether to authorize the second redemption. This step is similar to step 440 for the first redemption.

Step 495. If the central processor (or provider) determines not to authorize redemption of the second product, then the process may stop in step 495. This step may proceed in a manner similar to step 455 for the first product.

In step 500, a request to provide the second product to the customer may be passed to a second provider. This step is similar to step 460 for the first provider. It should be noted that the second provider may be identical to the first provider, or the second provider may be different from the first provider.

In step 510, the second provider may provide the second product to the customer. This step is similar to step 470 for the first provider.

It should be noted that steps 430-460 (or steps 480-510) may be repeated for a plurality of redemption requests. For instance, the process may repeat and products may be redeemed until all of the products associated with the identifier (e.g., the entire set of products redeemable by the identifier) are redeemed. For each product redemption, the database may be amended and/or updated to reflect that the specific product was redeemed so that it cannot be redeemed again. For instance, after a concert ticket is redeemed, the database may be amended to indicate that the concert ticket was redeemed for that identifier. If the customer tries to redeem the identifier for another concert ticket, the central processor may deny the request by determining that the request was already granted, as described in step 450. For products that may be redeemed in multiple iterations, the database may be amended to indicate the number or amount of remaining products of that type. For instance, if one product to be redeemed is 60 minutes of long distance telecommunications service, then the customer may redeem the 60 minutes over the course of several uses. For each use, the database may be amended to indicate the remaining value.

It will also be understood that in some embodiments, the authorization criteria for a particular identifier may not allow for multiple redemptions, in which case the second request will always be denied.

The embodiments of the present inventions are not to be limited in scope by the specific embodiments described herein. Indeed, numerous variations, changes, substitutions and equivalents will be apparent to those skilled in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, it is intended that all subject matter described herein and shown in the accompanying drawings be regarded as illustrative only and not in a limiting sense and that the scope of the invention be solely determined by the appended claims. Also, the claims set forth below should be construed in view of the full breadth and spirit of the embodiments of the present inventions as disclosed herein.

1. A method of enabling a customer to obtain one or more of a predetermined set of products through the use of a unique identifier, the method comprising:
establishing a database comprising a plurality of unique identifiers, each identifier being associated in the database with a set of products, each identifier being redeemable for the set of products;
distributing indicia of a selected one of said plurality of unique identifiers to a customer;
receiving a first request from a requester to redeem the selected identifier for a first product;
determining whether to authorize redemption of the selected identifier for the first product; and
issuing a first authorization result message to the requester.

2. The method of claim 1, wherein the set of products comprises at least two different products.

3. The method of claim 1, wherein the set of products comprises at least two different products, each redeemable from a different provider.

4. The method of claim 1, further comprising:
passing to a first provider a request to provide a first product to the customer, wherein the first product is one of the set of products;
passing a redemption confirmation to the requestor; and
amending the database to indicate that the first product has been redeemed.

5. The method of claim 1, wherein the action of distributing to the customer comprises distributing the indicia to a merchant for distribution to a customer.

6. The method of claim 5, wherein the action of distributing to the customer comprises selling a product to the customer, wherein the product is associated with the identifier.

7. The method of claim 1, wherein the action of distributing to the customer comprises including the indicia with a point-of-sale product that may be purchased by the customer.

8. The method of claim 7, wherein indicia is physically coupled to the point-of-sale product.

9. The method of claim 7 wherein the indicia is disposed within a packaging of the point-of-sale product.

10. The method of claim 1, wherein the indicia comprises a stored value card.

11. The method of claim 1, wherein the step of determining comprises determining whether the first product is one of the set of products associated with the identifier.

12. The method of claim 1, further comprising:
determining whether the identifier is in the database.

13. The method of claim 1, wherein the action of determining whether to fulfill the request comprises accessing the database and processing information stored in the database associated with the specific identifier.

14. The method of claim 1, further comprising:
passing a fulfillment instruction to a provider to provide the first product to the customer.

15. The method of claim 1, wherein the product is a product or service.

16. The method of claim 1, wherein the product is associated with a plurality of units of value, wherein the units are separately redeemable.

17. The method of claim 1, wherein the product comprises downloadable content.

18. The method of claim 1, wherein the product comprises telecommunications service.

19. The method of claim 1, further comprising:
receiving a payment for the first product from the customer.

20. The method of claim 1, further comprising:
receiving a second request from the customer to redeem the selected identifier for a second product, wherein the second product is one of the set of products.

21. The method of claim 20, further comprising:
determining whether to authorize redemption of the selected identifier for the second product; and
issuing a second authorization result message to the customer.

22. The method of claim 1, wherein the request is received over the Internet.

23. The method of claim 1, wherein each of a plurality of the set of products is associated with a separate account.

24. The method of claim 1, wherein the indicia comprises a redemption coupon.

25. The method of claim 1, wherein the indicia comprises a redemption card.

26. The method of claim 25, wherein the redemption card includes a machine readable medium having the identifier stored therein.

27. The method of claim 1, wherein the identifier is redeemable for each of the set of products.

28. The method of claim 1, wherein the identifier is redeemable for at least one physical product and at least one electronic product.

29. The method of claim 1, wherein the indicia comprises a receipt having the identifier printed thereon.

30. A method of distributing an identifier, comprising:
receiving a request for a product based on a unique identifier, wherein the product is one of a set of products associated with the identifier in a database, and wherein the identifier is usable to redeem each of the set of products; and
distributing the product to a customer.

31. The method of claim 30, wherein the request is received from the customer.

32. The method of claim 30, wherein the request is received from a central processor, further comprising:
passing a redemption confirmation to the central processor.

33. The method of claim 30, wherein the request comprises the identifier, further comprising:
determining whether to provide the first product to the customer based on whether the identifier is redeemable for the first product.

34. A system for distributing an identifier, comprising:
a database for storing a plurality of unique identifiers, each identifier being associated in the database with a set of products which can be redeemed by the identifier;
an output device for passing indicia of a selected one of said plurality of unique identifiers for distribution to a customer;
an input device for receiving a first request from the customer to redeem the selected identifier for a first product;
a processor for determining whether to authorize redemption of the selected identifier for the first product; and
an output device for issuing a first authorization result message to the customer.

35. A computer-readable medium encoded with computer program code to redeem products, the program code effective to perform the following:
establish a database comprising a plurality of unique identifiers, each identifier being associated in the database with a set of products, each identifier being redeemable for the set of products;
distribute indicia of a selected one of said plurality of unique identifiers to a customer;
receive a first request from a requestor to redeem the selected identifier for a first product;
determine whether to authorize redemption of the selected identifier for the first product; and
issue a first authorization result message to the requestor.

36. A method of providing a PIN, comprising:
providing a PIN with a product, wherein the PIN is associated with a plurality of products including a first and second product, wherein each product is separately redeemable, and wherein each product is redeemable through a separate distribution channel;
receiving a first request to redeem the first product, wherein the first request comprises the PIN;
determining whether the PIN is associated with the first product;
redeeming the first product through a first distribution channel;
receiving a second request to redeem the second product, wherein the second request comprises the PIN;
determining whether the PIN is associated with the second product; and
redeeming the second product through a second distribution channel.

37. The method of claim 35, wherein the first distribution channel is different from the second distribution channel.
